(19) United States
(12) Patent Application Publication
(10) Pub. No.: US 2025/0296544 A1
(43) Pub. Date: Sep. 25, 2025

(54) ELECTROMECHANICAL BRAKE SYSTEM AND VEHICLE

(71) Applicant: ZF CV Systems Global GmbH, Bern (CH)

(72) Inventors: Peter Beier, Wunstorf (DE); Jan Cohrs, Hannover (DE); Christoph Moritz, Hannover (DE); Robert Otremba, Ronnenberg (DE); Julian Van Thiel, Grossburgwedel (DE)

(21) Appl. No.: 18/860,747

(22) PCT Filed: Apr. 29, 2022
(86) PCT No.: PCT/EP2022/061575

§ 371 Date: Oct. 28, 2024

(51) Int. Cl. B60T 13/74; B60T 8/17; F16D 127/06

(52) U.S. Cl. CPC B60T 13/746; B60T 8/17; B60T 2260/09; B60T 2270/402; B60T 2270/413; F16D 2127/06

(57) ABSTRACT

An electromechanical brake system (10) includes a first energy supply apparatus (20) and a second energy supply apparatus (21), a first system control device (30) and a second system control device (31), a plurality of electromechanical brake actuator devices (41), and a first plurality and a second plurality of electronic brake control systems (40a, 40b). Each of the electronic brake control systems is set up to control one of the electromechanical brake actuator devices. The first energy supply apparatus is connected to the first system control device and to each of the first electronic brake control systems, and the second energy supply apparatus is connected to the second system control device and to each of the second electronic brake control systems. A further control device (32, 47) may be connected to at least one of the first electronic brake control systems or one of the second electronic brake control systems.

### FIELD

The present disclosure relates to an electromechanical brake system. The present disclosure also relates to a vehicle, in particular a utility vehicle.

### BACKGROUND

In the case of pneumatic systems, the pneumatic redundancy of the brake system control system is switched in the event of an electrical fault. In many cases, this means that wheel-specific brake force control is not possible. These restrictions do not allow stability functions such as an electronic stability control (ESC) system for motor vehicles to be used without additional external aids and/or auxiliary systems, which can result in a safety risk and means that the vehicle behavior, in particular a speed, a distance from another vehicle, and/or a driving maneuver, must be adapted.

These restrictions must be known, especially in an automated driving mode. In addition, in an automated driving mode, a complex fault response is necessary to avoid hazardous situations.

Furthermore, the energy supply of the brake actuator system is not redundant in pneumatic brake systems. Thus, in the prior art, a single fault in the energy transmission system, for example a pneumatic line breaking, can lead to the complete loss of braking force on at least one wheel.

The presented restrictions on availability and the resulting loss of vehicle stability are unsuitable in particular for highly automated vehicle applications and conflict with the development and use of highly automated vehicles.

Thus, in the event of a fault, pneumatic brake systems transition to an operating mode in which a compromise between reduced braking performance and/or braking functionality is reached by resorting to a pneumatic redundancy control system.

WO 2021/122214 A1 discloses an electromechanical brake system. The electromechanical brake system comprises a plurality of voltage supply units for supplying electrical energy to electrical brake devices. The voltage supply units are of redundant design by virtue of two voltage supply subunits being provided for each voltage supply unit. The two voltage supply subunits are set up to supply an electrical voltage to each set of motor windings of a motor of one of the electrical brake devices.

DE 10 2009 046 238 B4 discloses an electrical brake system having at least two brake circuits, each comprising a first control unit for converting a brake request of a driver into an actuation signal and at least one second control unit, which processes the actuation signal and actuates a wheel brake. Provision is made here for each wheel brake to be assigned a second control unit of the first and the second brake circuit, respectively.

### SUMMARY

The present disclosure is based on the object of enhancing the prior art and providing an improved brake system, which in the case of electrical faults reliably and effectively provides a high braking performance and functionality.

The object is achieved by an electromechanical brake system as disclosed herein and a vehicle, in particular a utility vehicle, as disclosed herein. The present disclosure additionally sets forth further preferred developments.

The present disclosure provides an electromechanical brake system for a vehicle, in particular a utility vehicle. The electromechanical brake system includes a first energy supply apparatus and a second energy supply apparatus, a first system control device and a second system control device, a plurality of electromechanical brake actuator devices, a first plurality of electronic brake control systems and a second plurality of electronic brake control systems, wherein each of the electronic brake control systems is set up to control one of the electromechanical brake actuator devices, wherein the first energy supply apparatus is connected to the first system control device and to each of the first electronic brake control systems to supply electrical energy, and the first system control device is connected to each of the first electronic brake control systems to transmit control signals, and the second energy supply apparatus is connected to the second system control device and to each of the second electronic brake control systems to supply electrical energy, and the second system control device is connected to each of the second electronic brake control systems to transmit control signals, wherein the electromechanical brake system has a further control device, wherein the further control device is connected to at least one of the first electronic brake control systems and/or one of the second electronic brake control systems to transmit control signals.

Each of the electronic brake control systems is set up to control one of the plurality of electromechanical brake actuator devices. Each of the electronic brake control systems can therefore apply a voltage to an electromechanical brake actuator device for controlling and/or for activating the electromechanical brake actuator device.

The first energy supply apparatus is set up to supply the first electronic brake control systems and the first system control device with electrical energy in order to enable the functioning of the electronic brake control systems and the first system control device. The first system control device is set up to apply a control signal to the first electronic brake control systems in order to activate an electromechanical brake actuator device connected to one of the first electronic brake control systems.

Analogously, the second energy supply apparatus is set up to supply the second electronic brake control systems and the second system control device with electrical energy in order to enable the functioning of the second electronic brake control systems and the second system control device. The second system control device is set up to apply a control signal to the second electronic brake control systems in order to activate an electromechanical brake actuator device connected to one of the second electronic brake control systems.

The further control device is a device that is different from the first system control device and the second system control device. The further control device is connected to the respective brake control system or systems to control one or more of the brake control systems. The further control device can thus be set up to transmit control signals to a specific selection of first and/or second electronic brake control systems, for example, on an axle and thus provide further redundancy. As an alternative or in addition, the further control device may be set up to transmit control signals to the first electronic brake control systems, which are also connected to the first system control device to receive control signals in order to provide a control device that is redundant to the first system control device. As an alternative or in addition, the further control device may be set up to transmit control signals to the second electronic brake control systems, which are also connected to the second system control device to receive control signals in order to provide a control device that is redundant to the second system control device.

The present disclosure has identified that redundancy of the energy supply and the control system is desirable in order to improve the braking performance and functionality in the event of an electrical fault. The first energy supply apparatus, the first system control device and the first electronic brake control systems in this case form a primary system. The second energy supply apparatus, the second system control device and the second electronic brake control systems form a secondary system. The primary system and the secondary system are mutually redundant systems, thus ensuring that an electrical fault in one of the systems does not cause the other system to fail. The further control device forms an additional fallback level in the event of a fault.

This makes it possible to provide a system design with electromechanical brakes for maximum braking performance and functionality in the event of electrical faults.

In other words, the primary and secondary system each comprise an independent electrical energy storage unit, an electrical system controller, and an electrical motor control system for each wheel brake. Each brake actuator system on the wheel thus consists of two independent control units. As a result, each mechanical friction brake can be actuated redundantly via the primary and secondary system. This enables wheel-specific brake force control in the event of single faults thanks to the redundant energy transmission and signal transmission right up to the wheel, which increases the availability of safety-critical braking functions such as ESC, for example. In addition, options for a second, additional fallback level can be implemented in order to achieve a safe vehicle state in the event of further faults.

Each of the system control devices preferably has a fieldbus interface. In other words, the first system control device includes a fieldbus interface and the second system control device includes a fieldbus interface. The fieldbus is, for example, a vehicle bus, in particular a CAN bus. This makes it possible for both a driver, for example via the service brake sensor (foot brake pedal) and parking brake sensor (parking brake switch), as well as a virtual driver to communicate redundantly with the brake system and to request decelerations via the fieldbus interface.

Each of the brake actuator devices preferably has at least one electromechanical locking mechanism in order to be able to ensure that each of the wheels are locked, even in the event of a fault. Each of the brake actuator devices optionally has two locking brake mechanisms, wherein a first locking brake mechanism can be activated by one of the first brake control systems, and wherein a second locking brake mechanism can be activated by one of the second brake control systems.

The energy supply apparatuses and/or the brake actuators of a brake actuator device are preferably similar in each case. The primary system and the secondary system are thus identical and provide the same functionalities. A failure of one component in one of the systems can therefore be compensated by the other system taking over. As an alternative, the energy supply apparatuses and/or the brake actuators of a brake actuator device are different from one another in each case. Thus, for example, energy storage units and electric motors for the secondary system can also be optimized in terms of cost, wherein the secondary system is set up to cover a functionality according to a fallback scenario. This can ensure, for example, minimal vehicle deceleration, for example in order to comply with legal requirements.

A first subset of the brake control systems preferably has an extended brake control unit, wherein the extended brake control unit has a fieldbus interface, the first subset of the brake control systems is connected to a second subset of the brake control systems and can be connected to a vehicle bus via the fieldbus interface to transmit control signals, and wherein the extended brake control unit forms the further control device. This embodiment allows an extended fallback level for the secondary system. For this purpose, an electric motor control system is functionally extended by implementing rudimentary braking logic in the form of the extended brake control unit. The extended brake control unit can communicate both with a virtual driver via the vehicle bus as well as with at least one additional connected brake control system in order to receive corresponding control signals from the fieldbus interface and/or to transmit same to the connected brake control system. This means that, in certain critical multiple fault scenarios, for example failure of the primary and secondary system control device, safety-relevant driving maneuvers are still possible and so the vehicle can be decelerated and stopped safely.

The electromechanical brake system preferably has a third energy supply apparatus and a third system control device, wherein the third energy supply apparatus is connected to the third system control device and to each of the second electronic brake control systems to supply electrical energy, the third system control device is connected to each of the first electronic brake control systems to transmit control signals, and wherein the third system control device forms the further control device. In another embodiment, the third energy supply device is not part of the brake system, but may, for example, also be primarily assigned to the steering system and used by the brake system if necessary. In this case, the third energy supply device can be connected to the brake system. In these preferred embodiments, based on the primary system and the secondary system, an extended, independent fallback level for the secondary system is implemented. This fallback level consists of an additional system controller with dedicated energy storage unit. Independent redundancy is achieved by the third system controller being able to communicate with both the virtual driver via the vehicle bus and with the wheel brakes, that is to say the brake control systems, independently of the primary and secondary system control system. This fallback level ensures high system availability and is particularly suitable for highly automated driving applications and driving maneuvers in which immediate stopping of the vehicle is undesirable in the event of critical single faults or failure of the primary system.

The third energy supply apparatus is preferably connected to the first energy supply apparatus and to the second energy supply apparatus to supply electrical energy. The energy supply of the third energy supply apparatus is provided by the upstream first energy supply apparatus and the upstream second energy supply apparatus. This enables a defined amount of energy and power to be provided in the event of a primary and secondary system failure.

Each of the energy supply apparatuses preferably has an electrical output, which is set up to electrically connect the energy storage unit to a vehicle system different from the electromechanical brake system. This makes it possible for the energy storage units to be able to be used for other vehicle systems, such as steering systems and/or communication systems. The connected systems can be prioritized here either by one of the system control devices and/or a virtual driver via a vehicle bus.

Each of the brake actuator devices preferably has two mutually redundant brake actuators. As an alternative or in addition, each of the brake actuator devices has a brake actuator with two mutually redundant sets of windings. In these embodiments, each of the brake actuator devices includes what is known as a dual motor for activating the brake. This makes it possible for each energy storage device and respectively each motor winding of the electric dual motor to cover the demand for maximum transferable braking force with high control dynamics.

The electronic brake control systems are preferably set up in such a way that each of the electromechanical brake actuator devices can be controlled by one of the first plurality of electronic brake control systems and by one of the second plurality of electronic brake control systems. In this embodiment, the control system of each of the electromechanical brake actuator devices is redundant. Each of the electromechanical brake actuator devices can thus be actuated by two different electronic brake control systems, namely by one of the first plurality of electronic brake control systems and by one of the second plurality of electronic brake control systems.

One aspect of the present disclosure provides a vehicle, in particular a utility vehicle. The vehicle, in particular the utility vehicle, includes an electromechanical brake system as described above. The brake system optionally includes the features described as advantageous and/or optional in order to achieve an associated technical effect.

In other words, one embodiment of the present disclosure can be summarized as follows: The present disclosure describes a brake system having electromechanical brakes, EMB, on at least one axle, wherein the brake system can be designed in such a way that, in addition to a primary system of the operating brake system, a fully redundant secondary system with optionally the same braking performance and functionality is provided. In addition to the secondary system, depending on the application, an additional fallback level can be provided in different embodiments. Provision is made for a virtual driver in particular to have access to all levels of the brake system in order to implement vehicle operation in automated/autonomous driving applications.

### BRIEF DESCRIPTION OF THE DRAWINGS

Further advantages and features of the present disclosure as well as the technical effects thereof result from the figures and the description of the preferred embodiments shown in the figures. In the figures:

FIG. 1 shows a schematic illustration of an electromechanical brake system;

FIG. 2 shows a schematic illustration of an electromechanical brake system according to one embodiment of the present disclosure;

FIG. 3 shows a schematic illustration of an electromechanical brake system according to another embodiment of the present disclosure;

FIG. 4 shows a schematic illustration of an electromechanical brake system according to another embodiment of the present disclosure; and

FIG. 5 shows a schematic illustration of a vehicle, in particular a utility vehicle, according to one embodiment of the present disclosure.

### DETAILED DESCRIPTION

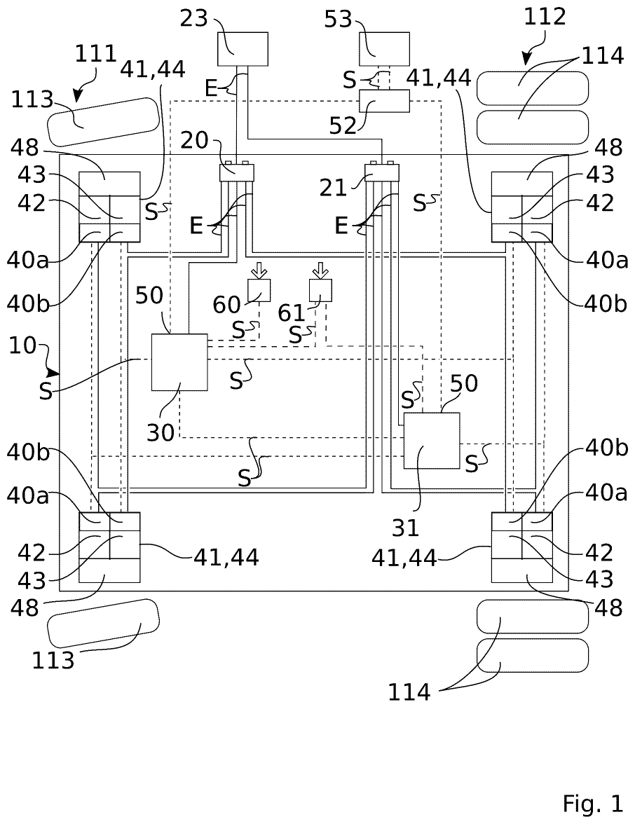

FIG. 1 shows a schematic illustration of an electromechanical brake system 10.

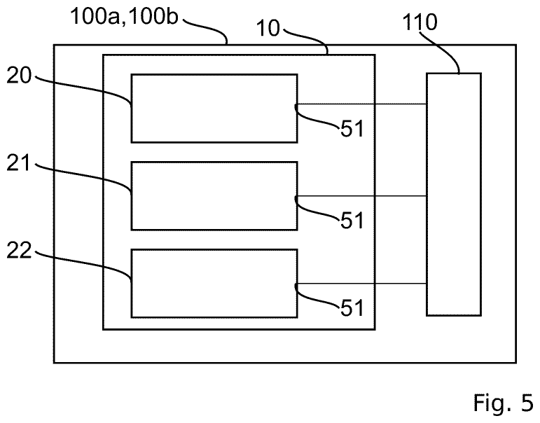

The electromechanical brake system 10 is a brake system for a vehicle 100a, in particular a utility vehicle 100b. The vehicle 100a, in particular the utility vehicle 100b, is described with reference to FIG. 5. The vehicle 100a, in particular the utility vehicle 100b, is hereinafter referred to as vehicle 100a, 100b.

As shown in FIG. 1, the electromechanical brake system 10 is set up for use in a vehicle 100a, 100b having a front axle 111 and a rear axle 112. Two steerable front wheels 113 are arranged on the front axle 111. On the rear axle 112, four rear wheels 114 are arranged as twin wheels.

Each of the axles 111, 112 or each of the wheels 113, 114 can be braked by the brake system 10. For this purpose, two brake actuator devices 41, which are included by the electromechanical brake system 10, are arranged on each of the axles 111, 112.

The electromechanical brake system 10 includes a first energy supply apparatus 20 and a second energy supply apparatus 21. To supply electrical energy E to the first energy supply apparatus 20 and the second energy supply apparatus 21, the first energy supply apparatus 20 and the second energy supply apparatus 21 are each connected to a system energy supply apparatus 23, as illustrated by solid lines. The system energy supply apparatus 23 is, for example, a vehicle-based, in particular rechargeable, battery. The first energy supply apparatus 20 and the second energy supply apparatus 21 are batteries and/or capacitors included in the brake system 10 for storing and providing electrical energy E for the brake system 10.

The electromechanical brake system 10 includes a first system control device 30 and a second system control device 31. The system control devices 30, 31 each have a fieldbus interface 50 to connect the respective system control device 30, 31 to a vehicle bus 52. The fieldbus interfaces 50 are, in particular, CAN interfaces and the vehicle bus 52 is a CAN bus. The vehicle bus 52 can transmit control signals S from a vehicle-based controller 53, for example an electronic control unit (ECU), via the fieldbus interfaces 50 to each of the system control devices 30, 31. The system control devices 30, 31 each comprise a data processing apparatus having a processor and a memory to process the control signals S. The system control devices 30, 31 are connected to one another in order to transmit and/or receive control signals S between themselves. For example, the system control devices 30, 31 can transmit status queries and status information relating to the functionality and/or a fault in a primary and/or secondary system. The first system control device 30 is connected to a first input 60 and a second input 61 to receive control signals S. The second system control device 31 is connected to the second input 61 to receive control signals S. The inputs 60, 61 are arranged on the vehicle side and can be activated by a driver of the vehicle 100a, 100b to input control signals S for braking. The inputs 60, 61 may include an encoder that can be metered gradually and/or a switch.

The electromechanical brake system 10 includes a first plurality of electronic brake control systems 40b and a second plurality of electronic brake control systems 40a. The first energy supply apparatus 20 is connected to the first system control device 30 and to each of the first electronic brake control systems 40b to supply electrical energy E, as illustrated by solid lines in each case. Analogously, the second energy supply apparatus 21 is connected to the second system control device 31 and to each of the second electronic brake control systems 40a to supply electrical energy E. The first system control device 30 is connected to each of the first electronic brake control systems 40b to transmit control signals S, as illustrated by dashed lines. The second system control device 30 is connected to each of the second electronic brake control systems 40b to transmit control signals S, as illustrated by dashed lines. The first plurality of electronic brake control systems 40b is different from the second plurality of electronic brake control systems 40a.

Each of the electronic brake control systems 40a, 40b is set up to control one of the electromechanical brake actuator devices 41. The electronic brake control systems 40a, 40b are set up in such a way that each of the electromechanical brake actuator devices 41 can be controlled by one of the first plurality of electronic brake control systems 40b and by one of the second plurality of electronic brake control systems 40b. Each brake actuator device 41 can thus be controlled redundantly. Each of the brake actuator devices 41 has two mutually redundant brake actuators 42, 43. In this case, a first of the brake actuators 43 can be activated by one of the first electronic brake control systems 40b and a second of the brake actuators 42 can be activated by one of the second electronic brake control systems 40a. Each of the brake actuators 42, 43 acts on a brake caliper 48 in order to brake one of the wheels 113, 114. For each of the wheels 113, 114, one of the first plurality of electronic brake control systems 40b and one of the second plurality of electronic brake control systems 40a is set up to be controlled by a control signal S for braking the respective wheel 113, 114.

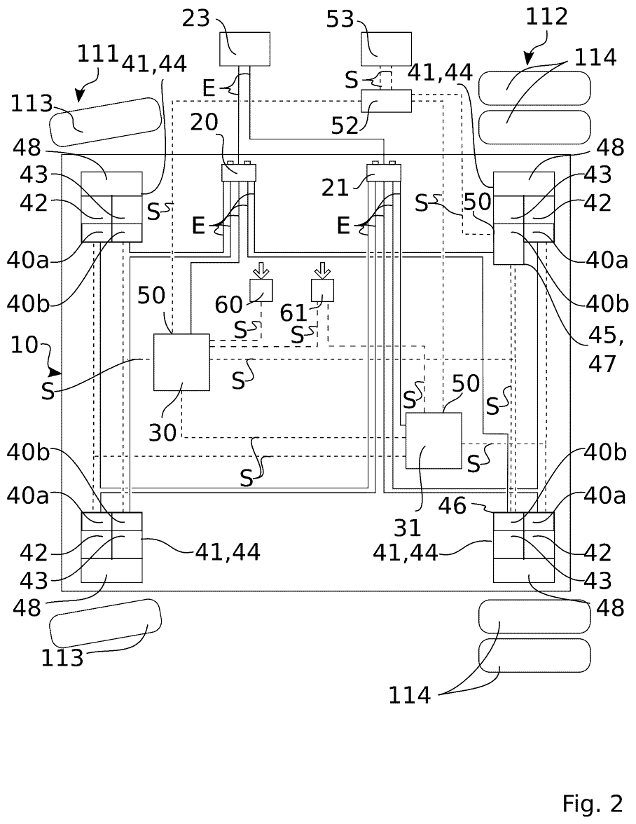

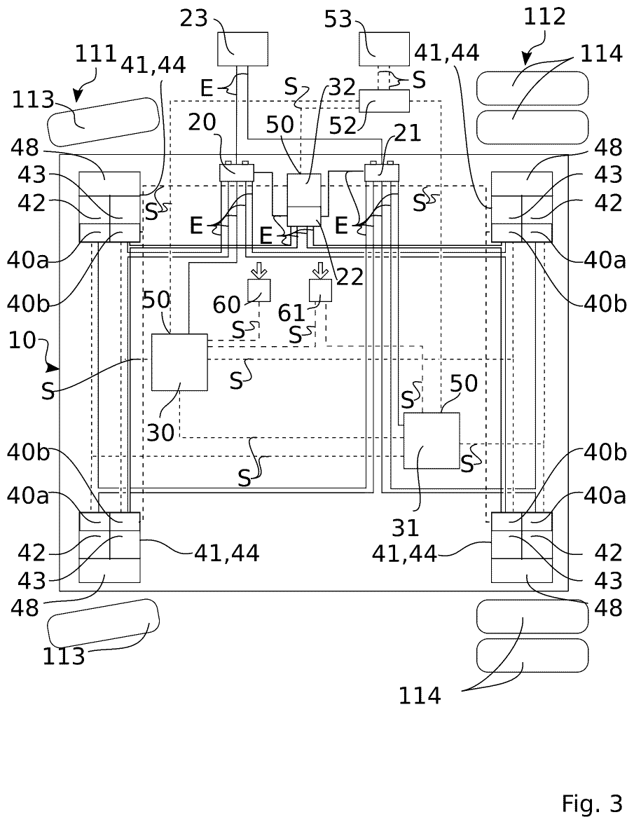

The first energy supply apparatus 20, the first system control device 30 and the first electronic brake control systems 40b form a primary system. The second energy supply apparatus 21, the second system control device 31 and the second electronic brake control systems 40a form a secondary system. The primary system and the secondary system are mutually redundant systems. This means that each mechanical friction brake can be actuated redundantly via the primary and secondary system. This enables wheel-specific brake force control in the event of single faults thanks to the redundant energy transmission E and signal transmission S right up to the wheel 113, 114. In addition, options for a second, additional fallback level can be implemented (see FIGS. 2 and 3) in order to achieve a safe vehicle state in the event of further faults.

Each of the brake actuator devices 41 has at least one electromechanical locking mechanism 44. The energy supply apparatuses 20, 21 and the brake actuators 42, 43 of a brake actuator device 41 are similar in each case. In one embodiment that is not shown, the energy supply apparatuses 20, 21, the brake actuators 42, 43 and a brake actuator device 41 may be different from one another.

FIG. 2 shows a schematic illustration of an electromechanical brake system 10 according to one embodiment of the present disclosure. The embodiment of the electromechanical brake system 10 according to FIG. 2 is based on the embodiment of the electromechanical brake system 10 according to FIG. 1 and is described in terms of the differences to FIG. 1.

The electromechanical brake system 10 has a first subset of brake control systems 45. In the example shown, the first subset of brake control systems 45 is provided by the first brake control system 40b on the rear axle on the wheels 114 in the direction of travel to the right. The first subset of brake control systems 45 has an extended brake control unit 47. The extended brake control unit 47 forms a control device 32, 47, which is connected to one of the first electronic brake control systems 40b to transmit control signals S. Rudimentary braking logic is implemented in the extended brake control unit 47. For this purpose, the extended brake control unit 47 includes a data processing device and a memory (not shown). The extended brake control unit 47 has a fieldbus interface 50 in order to receive control signals S via a vehicle bus 52. The first subset of brake control systems 45 is connected to a second subset of brake control systems 46 to transmit control signals S. In the example shown, the second subset of brake control systems 46 is provided by the first brake control system 40b on the rear axle on the wheels 114 in the direction of travel to the left. In other words, the first subset of brake control systems 45 includes the extended brake control unit 47. The second subset of brake control systems 46 is connected to the extended brake control unit 47 to receive control signals S. The extended brake control unit 47 can thus receive a control signal S via the vehicle bus 52 and accordingly actuate the first brake control system 40b on the rear axle 112 independently of the first system control device 30 and the second system control device 31. This results in improved redundancy and it is thus possible to compensate for a multiple fault.

The extended brake control unit 47 is connected to the first system control device 30 and to the second system control device 31 to transmit control signals S. For example, status queries and status information, which relate to the functionality and/or a fault in the primary system, secondary system and/or in the extended brake control unit 47, can be transmitted between the extended brake control unit 47 and the system control devices 30, 31.

FIG. 3 shows a schematic illustration of an electromechanical brake system 10 according to another embodiment of the present disclosure. The embodiment of the electromechanical brake system 10 according to FIG. 3 is based on the embodiment of the electromechanical brake system 10 according to FIG. 1 and is described in terms of the differences to FIG. 1.

The electromechanical brake system 10 has a third energy supply apparatus 22 and a third system control device 32. The third energy supply apparatus 22 is connected to the third system control device 32 and to each of the first electronic brake control systems 40b to supply electrical energy E. The third system control device 32 is connected to each of the first electronic brake control systems 40b to transmit control signals S. The third system control device 32 forms a further control device 32, 47, which is connected to each of the first electronic brake control systems 40b to transmit control signals S. This implements a second fallback level, which can compensate for faults in the primary system and in the secondary system.

The third energy supply apparatus 22 is connected to the first energy supply apparatus 20 and to the second energy supply apparatus 21 to supply electrical energy E. The energy supply of the third energy supply apparatus 22 is provided by the upstream first energy supply apparatus 20 and the upstream second energy supply apparatus 21.

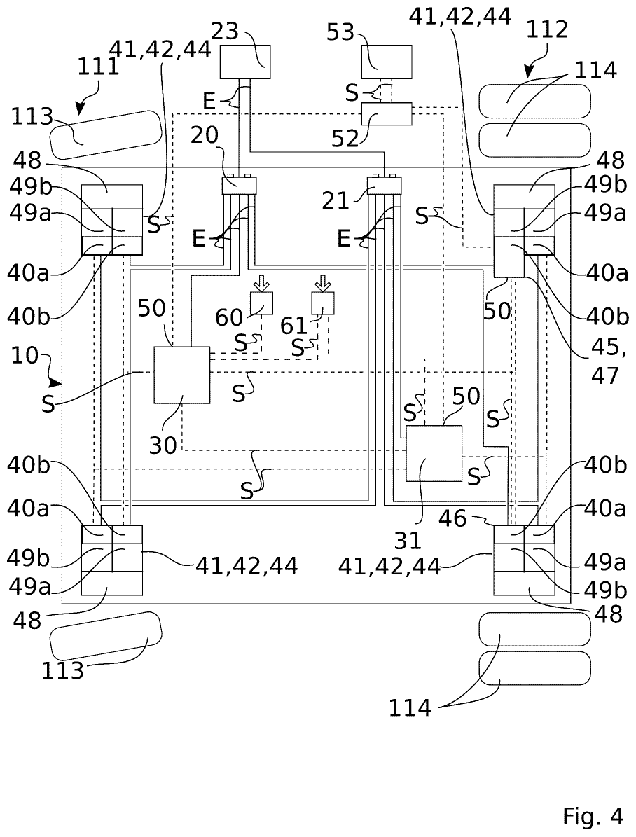

FIG. 4 shows a schematic illustration of an electromechanical brake system 10 according to another embodiment of the present disclosure. The embodiment of the electromechanical brake system 10 according to FIG. 4 is based on the embodiment of the electromechanical brake system 10 according to FIG. 2 and is described in terms of the differences to FIG. 2.

Each of the brake actuator devices 41 has a brake actuator 42 having two mutually redundant sets of windings 49a, 49b. Each of the windings 49a, 49b is set up to activate the brake actuator 42 when supplied with electrical energy. In this case, a first of the sets of windings 49b can be supplied with electrical energy by one of the first electronic brake control systems 40b and a second of the sets of windings 49a can be supplied with electrical energy by one of the second electronic brake control systems 40a. Each of the brake actuators 42 acts on a brake caliper 48 in order to brake one of the wheels 113, 114. For each of the wheels 113, 114, one of the first plurality of electronic brake control systems 40b and one of the second plurality of electronic brake control systems 40a is set up to be controlled by a control signal S for braking the respective wheel 113, 114.

Analogously, the brake actuators 41 described with reference to FIG. 4 can also be used in an embodiment according to FIG. 3.

FIG. 5 shows a schematic illustration of a vehicle 100a, in particular a utility vehicle 100b, according to one embodiment of the present disclosure.

The vehicle 100a, 100b is an automated or partially autonomous and/or autonomous vehicle 100a, 100b. The vehicle 100a, 100b is set up to be operated (partially) automatically and to perform driving maneuvers (partially) automatically. The vehicle 100a, 100b is set up to (partially) automatically activate a brake of the vehicle 100a, 100b.

The vehicle 100a, 100b includes an electromechanical brake system 10 as described with reference to one of FIGS. 1 to 4, wherein the electromechanical brake system 10 in the embodiment shown has three energy supply apparatuses 20, 21, 22. Each of the energy supply apparatuses 20, 21, 22 has an electrical output 51, which is set up to electrically connect the energy storage unit 20, 21, 22 to a vehicle system 110 different from the electromechanical brake system 10.

### REFERENCE SIGNS (PART OF THE DESCRIPTION)

10 Electromechanical brake system
20 First energy supply apparatus
21 Second energy supply apparatus
22 Third energy supply apparatus
23 System energy supply apparatus
30 First system control device
31 Second system control device
32 Third system control device
40a Electronic brake control system
40b Electronic brake control system
41 Electromechanical brake actuator device
42 Brake actuator
43 Brake actuator
44 Electromechanical locking mechanism
45 First subset of brake control systems
46 Second subset of brake control systems
47 Extended brake control unit
48 Brake caliper
49a Set of windings
49b Set of windings
50 Fieldbus interface
51 Electrical output

### 52 Vehicle bus

### 53 Controller

60 First input
61 Second input

### 100a Vehicle

100b Utility vehicle
110 Vehicle system
111 Front axle
112 Rear axle
113 Front wheel
114 Rear wheel

### E Energy

S Control signal

1. An electromechanical brake system (10) for a vehicle (100a), comprising:
a first energy supply apparatus (20) and a second energy supply apparatus (21),
a first system control device (30) and a second system control device (31),
a plurality of electromechanical brake actuator devices (41),
a first plurality of electronic brake control systems (40b) and a second plurality of electronic brake control systems (40a), wherein each of the electronic brake control systems (40a, 40b) is set up to control one of the electromechanical brake actuator devices (41), wherein
the first energy supply apparatus (20) is connected to the first system control device (30) and to each of the first electronic brake control systems (40b) to supply electrical energy (E), and the first system control device (30) is connected to each of the first electronic brake control systems (40b) to transmit control signals (S), and
the second energy supply apparatus (21) is connected to the second system control device (31) and to each of the second electronic brake control systems (40a) to supply electrical energy (E), and the second system control device (30) is connected to each of the second electronic brake control systems (40a) to transmit control signals (S), and
a further control device (32, 47), wherein the further control device (32, 47) is connected to at least one of the first electronic brake control systems (40b) and/or at least one of the second electronic brake control systems (40a) to transmit control signals (S).

2. The electromechanical brake system as claimed in claim 1, wherein each of the system control devices (30, 31, 32) has a fieldbus interface (50).

3. The electromechanical brake system as claimed in claim 2, wherein each of the brake actuator devices (41) has at least one electromechanical locking mechanism (44).

4. The electromechanical brake system as claimed in claim 1, wherein the first energy supply apparatus (20) and a first brake actuator of a brake actuator device (41) are in each case of a same type and provide a same functionality as the second energy supply apparatus (21) and a second brake actuator of the brake actuator device (41).

5. The electromechanical brake system as claimed in claim 1,
wherein a first subset (45) of the first and second electronic brake control systems (45) has an extended brake control unit (47),
wherein the extended brake control unit (47) has a fieldbus interface (50),
wherein the first subset (45) of the first and second electronic brake control systems (45) is connected to a second subset (46) of the first and second electronic brake control systems (46) and is connected to a vehicle bus (52) via the fieldbus interface (50) to transmit control signals (S), and
wherein the extended brake control unit (47) forms the further control device (32, 47).

6. The electromechanical brake system as claimed in claim 1,
wherein the electromechanical brake system (10) has a third energy supply apparatus (22) and a third system control device (32),
wherein the third energy supply apparatus (22) is connected to the third system control device (32) and to each of the first electronic brake control systems (40b) to supply electrical energy (E), and the third system control device (32) is connected to each of the first electronic brake control systems (40b) to transmit control signals (S), and
wherein the third system control device (32) forms the further control device (32, 47).

7. The electromechanical brake system as claimed in claim 6, wherein the third energy supply apparatus (22) is connected to the first energy supply apparatus (20) and to the second energy supply apparatus (21) to supply electrical energy (E).

8. The electromechanical brake system as claimed in claim 1, wherein each of the energy supply apparatuses (20, 21, 22) has an electrical output (51), which is set up to electrically connect an energy storage unit (20, 21, 22) to a vehicle system (110) different from the electromechanical brake system (10).

9. The electromechanical brake system as claimed in claim 1, wherein each of the brake actuator devices (41) have two mutually redundant brake actuators (42, 43) or a brake actuator (42) having two mutually redundant sets of windings (49a, 49b).

10. The electromechanical brake system as claimed in claim 1, wherein the electronic brake control systems (40a, 40b) are set up in such a way that each of the electromechanical brake actuator devices (41) is controlled by one of the first plurality of electronic brake control systems and by one of the second plurality of electronic brake control systems (40b).

11. A vehicle (100a) comprising an electromechanical brake system (10) as claimed in claim 1.

12. The electromechanical brake system as claimed in claim 1, wherein the first energy supply apparatus (20) and/or a first brake actuators of a brake actuator device (41) are in each case of a different type and provide a different functionality relative to the second energy supply apparatus (21) and a second brake actuator of the brake actuator device (41).

13. The electromechanical brake system as claimed in claim 5, wherein the extended brake control unit communicates both with a virtual driver via the vehicle bus as well as with at least one additional connected brake control system.

14. The electromechanical brake system as claimed in claim 1, wherein The first energy supply apparatus (20) and the second energy supply apparatus (21) are batteries and/or capacitors.

15. The electromechanical brake system as claimed in claim 7, wherein an energy supply of the third energy supply apparatus is provided by the first energy supply apparatus and the second energy supply apparatus, each of which are upstream from the third energy supply apparatus.
